(19) United States
(12) Patent Application Publication
(10) Pub. No.: US 2008/0046132 A1
(43) Pub. Date: Feb. 21, 2008

(54) Control of heat dissipation

(75) Inventors: Lars Dalsgaard, Oulu (FI); Jarkko Eskelinen, Oulu (FI); Jarkko Koskela, Oulu (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/605,323

(22) Filed: Nov. 29, 2006

(30) Foreign Application Priority Data
Aug. 18, 2006 (EP) 06017298.8

(51) Int. Cl. G05D 23/00

(52) U.S. Cl. 700/299

(57) ABSTRACT

The present invention relates to preventing electronic devices (e.g., mobile terminal devices) from overheating in a communication network environment. Heat related information indicating heat generation or a simple temperature measurement at the terminal device may be sent to a network element causing the network element to adjust an inactivity period and/or a actual transmission data rate, (e.g. using a DRX/DTX parameter adjustment), so that no further rise in temperature at the terminal device occurs because of dissipation losses in the electronic components of the terminal device. Additionally, a control loop may be constituted starting at the terminal device, which detects the heat related information, provides the heat related information explicitly or implicitly to a network device, which in turn causes the network device to adjust the inactivity period and/or the transmission data rate base on the provided heat related information.

### RELATED APPLICATION INFORMATION

This application claims priority to European provisional application EP06017298.8, filed Aug. 18, 2006, whose contents are expressly incorporated herein by reference.

### FIELD OF THE INVENTION

The present invention relates to adjusting an inactivity period and/or an actual throughput of data transmission in relation to heat related information, wherein the heat related information is based on at least one of actual heat generation or actual temperature of electronic components or parts thereof in an electronic device.

### BACKGROUND

Portable electronic devices are operated in wide range of environmental conditions. One of the most problematic aspects thereof is temperature. It is possible to protect an electronic device from moist and light, but in most situations it is impossible to develop feasible solution to prevent impact of extreme heat or chilling cold on the device.

A cold environment does not pose major problem on most of the components of which an electronic device is comprised. Only components like displays and mechanics may be affected by cold. In contrast, warm or hot environments create a problem for electronic devices, in particular when the device is dissipating heat by its own. In other words, electronic devices having high heat dissipation in operation or certain modes of operation need a certain gap between its own temperature and the environmental temperature to be able to get rid of it thermal dissipations losses. In extreme cases an electronic device may overheat and, as a consequence, overheat might, for instance, cause the device to break or stop functioning temporally. Also, as heat generation, in particular thermal dissipations losses, comes along with device's intended operation, heat management is to be seen as a big issue.

Further, highest heat dissipation normally occurs during intensive use of the device. As mentioned above, there is a relation between the functional reliability of an electronic device and the heat which the device is exposed to, including the heat generation of device itself. Hence, the problem of overheating concerns, in particular electronic devices comprising high capacity processors or hardware components. One example for such an electronic device is a portable or mobile device alike a mobile phone, also called mobile terminal or mobile station, or more general user equipment (UE). In the recent times, such mobile communication devices have been developed to highly integrated functional devices providing high sophisticated functionalities as communication of voice, data as well as multi-media. For those purposes, the user equipment comprises powerful processing units and components. Also the size of the UE is related to its capabilities to get rid of heat. The trend of UE's becoming smaller and smaller results also in a smaller surface of the UE as heat interface to the surrounding air.

User equipment, as mobile terminals for mobile communication and data transmission generate a substantial amount of thermal dissipations if there is an ongoing active data transmission and/or reception. More particular, the actual data rate or amount of transmitted or received data is correlated with the generated dissipation losses by the equipment's own hardware components involved. For control of heat dissipation within a mobile device, for example control of hardware components used by a certain protocol, there are several aspects to consider.

First of all, temperature as an environmental condition varies highly. Environmental temperature is an external impact parameter which cannot be influenced. This causes issues with design as mentioned above.

Further, a device containing a certain protocol implementation may have to handle high throughput data transfers. A high data rate normally means increased heat generation within the device, but the assigned data rate is controlled by the network according to the user equipment's capability.

Furthermore, less or even no heat is generated during periods with non-active transmission or reception, that means cooling down is possible. Such non-activity periods are for example controlled through discontinuous reception (DRX) and discontinuous transmission (DTX) periods, which are, however, controlled in a centralized manner by a network element. In other words, the user equipment is not able to affect control of non-activity periods.

To sum it up, the worst case scenario could be that the user equipment is to be limited to lower throughputs to ensure operation on whole temperature range. Alternatively, development cost is expected to increase due to the need of equipment or devices which are able to handle high data rates throughout the whole temperature range. Nevertheless there are still problems posed on user equipment (UE) designs, because UE has to be designed to handle worst case scenarios, that is to say most extreme heat conditions with maximum throughput. Accordingly, there remains a need for techniques for controlling heat dissipation in electronic devices.

### SUMMARY

In light of the foregoing, the present invention relates to methods and devices for enabling flexible control of actual heat generation or actual temperature of electronic components caused by an operation condition of a device.

In a certain exemplary embodiment, a device-side method includes the steps of generating at a data receiving terminal device, being connected to a communication network sending data to the terminal device, heat related information based on at least one of actual heat generation or actual temperature of electronic components or parts thereof in the terminal device, sending the heat related information to the communication network, and causing the network to adjusting of an inactivity period and/or an actual throughput of data send to the terminal device from the communication network in response to the heat related information.

In another example, a network-side method includes the steps of receiving heat related information at a communication network from a terminal device connected thereto, wherein the heat related information being based on at least one of actual heat generation or actual temperature of electronic components or parts thereof in the terminal device, and adjusting of an inactivity period and/or an actual throughput of data send from the network to the terminal device in response to the heat related information.

According to another aspect, computer readable media (e.g., computer program products) may include code for producing the steps of methods similar to those described above when run on a computing device.

In yet another example, a terminal device may include at least one detector for heat related information based on at least one of actual heat generation or actual temperature of electronic components or parts thereof in the terminal device, and a signalling control unit configured to send the heat related information to a communication network, to which the terminal device is connected; wherein the heat related information is intended as reference information for the network in adjusting the inactivity period and/or an actual throughput of data transmission from the communication network to the terminal device.

In another example, a network element may include a control unit, by which network element is able to control throughput of data transmission on a communication connection the communication network to a terminal device connected to the network element, wherein the network element is configured to adjust an inactivity period and/or an actual throughput of data transmission upon reception of heat related information from the terminal device, wherein the heat related information is based on at least one of actual heat generation or actual temperature of electronic components or parts thereof in the terminal device.

Additional aspects relate to a system for adjusting an inactivity period and/or an actual throughput of data transmission on a communication connection the communication network to a terminal device connected to the network element in a communication network, the system including at least one terminal device and one network element similar to those described above.

Accordingly, certain embodiments relate to a simple and effective solution for an electronic device (e.g., a terminal device) to inform implicitly or explicitly a communication network to which the terminal device is connected to on its actual heat situation such that the communication network is caused to adjust or adapt the inactivity period and/or the actual throughput of data transmission, which in turn effects less dissipation losses in the electronic components of the terminal device which are involved in data reception. Hence, the terminal device may cause the communication network explicitly or implicitly to perform a required re-configuration of parameters affecting the timely averaged data throughput from the communication network to the terminal device.

Certain embodiments relate to a general idea based on the perception that in communication systems it is common that the network controls how often and how much a terminal device is allowed to send and/or receive data. The sending and reception of data on the terminal side generates heat and may in high load situations cause the UE to overheat. Certain embodiments relate to a way to handle this situation by enabling the user equipment (UE) to inform the communication network that it is in such a condition that the network should limit allocations for the UE in order to limit heat generation or for any other reasons found by UE. The same applies for the actual data throughput (data transmission rate), in particular by which data is send from the network the UE. In other words, reducing or throttling the data rate by the network also can reduce generation of heat in the UE.

One or more certain embodiments implement a new use of the DTX/DRX mechanism for control of discontinuous transmission (DTX) and/or discontinuous reception (DRX), which enables a protocol to be inactive at certain time period between actual active receptions and transmissions. Normally DRX is used in portable devices in order to preserve battery consumption which is one major priority. Generally, an electronic device does not produce heat while not actively used. In these embodiments, a way is introduced by which it is possible to reduce the power consumption and thereby the heat generation, by effectively allowing a decrease of the duty cycle of the protocol by use of the DRX/DTX mechanism. This may be handled by enabling the UE to inform the network that it is now in such a situation that the network should limit its allocations for the UE in order to limit the heat generation in the UE. The network is enabled to do this by adjusting the DRX and DTX cycle. The suggested use of, for instance, the DRX cycle as a control parameter of the identified problem is a novel use of the DRX/DTX mechanism.

### BRIEF DESCRIPTION OF THE DRAWINGS

Other objects and features will become apparent from the following detailed description considered in conjunction with the accompanying drawings. It is to be understood, however, that the drawings are designed solely for purposes of illustration and not as a definition of the limits of the invention, for which reference should be made to the appended claims only. It should be further understood that the drawings are merely intended to conceptually illustrate the structures and procedures described herein.

FIG. 1 shows a diagram illustrating a radio access network architecture, in accordance with certain aspects of the invention;

FIG. 2 shows a schematic block diagram representing a mobile terminal and a base station device of a radio access network, in accordance with certain aspects of the invention;

FIG. 3 shows a signalling diagram illustrating different signalling implementations, in accordance with certain aspects of the invention; and

FIG. 4 shows a schematic block diagram of a computer-based implementation, in accordance with certain aspects of the invention.

### DETAILED DESCRIPTION OF EMBODIMENTS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

The following embodiments, described in greater detail below, may operate in connection with a DRX/DTX-based overheating control procedure in a user equipment device (e.g., a mobile terminal), which uses a wireless connection to a base station device of a radio access network (RAN), such as the long-term evolution (LTE) of the 3GPP (3rd Generation Partnership Project) UTRAN (Universal Mobile Telecommunications System (UMTS) Terrestrial Radio Access Network), also called E-UTRAN.

Mobile protocols may implement commonly known forms of power saving mechanisms, such as discontinuous transmission (DTX) and/or discontinuous reception (DRX). In particular, DRX may be used in communication networks to conserve battery energy of receiving devices, such as mobile devices or user equipments (UE). The UE and the network may negotiate phases in which data transfer happens. Alternatively the network may command the phases at which the data transfer happens. This mechanism may enable a protocol, and possibly the whole device, to be inactive at certain time periods between actual active receptions and transmissions. Thus, using this mechanism, power consumption and heat generation may be potentially reduced. In other words, during the times the device has turned its receiver off; it may enter into a low-power state in which dissipation losses may also be reduced or even minimized.

The DRX and DTX mechanisms may effectively decrease the duty cycle of a protocol. For example, if a protocol is ordered to receive only every second possible transmission, duty cycle is ½. Roughly speaking, by reducing or decreasing the duty cycle for reception or transmission, dissipation losses related thereto may be avoided. Moreover, when the receiving or transmitting circuits are switched off there may be no heat dissipation or generation of heat at all. Hence, heat in the involved electronic components may be reduced. In other words, power consumption and heat generation are linked together.

In the UMTS Radio Access Network, DRX and DTX mechanisms may be typically utilized in paging states, where the UE is listening periodically to the paging channel. DRX period(s), triggers, and timers used in DRX may be configured by the Radio Resource Control (RRC) functionality. Also, the network may direct inactive UEs to DRX by explicit commands.

As UE dissipation losses greatly depend on how often UE has to turn on its transceiver, it becomes clear from the above description that the DRX/DTX interval may have an impact on UE dissipation losses, that is, heat generation in the circuit components involved. Thus, one way of preventing overheating is to enable the use of DRX/DTX in such a way that the network may adjust the DRX/DTX parameters such that the receiving operation of a terminal device does not generate more heat in the terminal device than the device is able to get rid of. More generally, if the network knows about the present heat situation of the terminal device, then the network may be able to adjust the transmission rate of data sent from the network to the terminal device. In other words, the use of the DRX/DTX mechanisms is only one approach to handle heat generation in the terminal device, by adapting the actual transmission data rate.

In LTE, which is a packet based system, it may be assumed that all resources are assigned more or less temporarily by the network to the UE by use of allocation tables (AT), or more generally by use of a downlink (DL) resource assignment channel. These assignments or allocations may be grouped into one-time allocations and persistent allocations. One time resource assignment means that through the AT the UE will receive uplink (UL) and/or DL resource allocations which are valid only once and for that particular allocation in time. Alternatively, UL/DL resources may be assigned temporarily for a longer time period—so—called persistent allocations. This longer resource assignment may be done for longer predetermined time or until new allocation information is signalled to the UE.

According to certain embodiments, information related to the temperature in the UE 10 or to the actual generated heat caused by dissipation losses (in short hereinafter “heat related information”) may be indicated by the UE as an overheating status information to the network 30, in particular the network device (e.g., a network element, the node B 20), which, in this example, is in charge of the allocation cycle time for the UE 10.

For the indication of excessive heat generation, the heat related information may be signalled from the UE 10 to the node B 20 by either L1, L2, or L3 level messaging. In the simplest implementation such heat related information might only include one bit indicating that UE 10 is or is not happy with current state/situation of heat generation. In other words, a one-bit heat related information may indicate to the network whether further adaptation or adjustment of the actual transmission data rate from the network 30 to the UE 10 may be required. Alternatively, the heat related information may include several bits which may indicate relative or absolute heat (e.g., corresponding to a relative or absolute heat measurement) in the UE 10 to the node B 20 or the network 30, respectively.

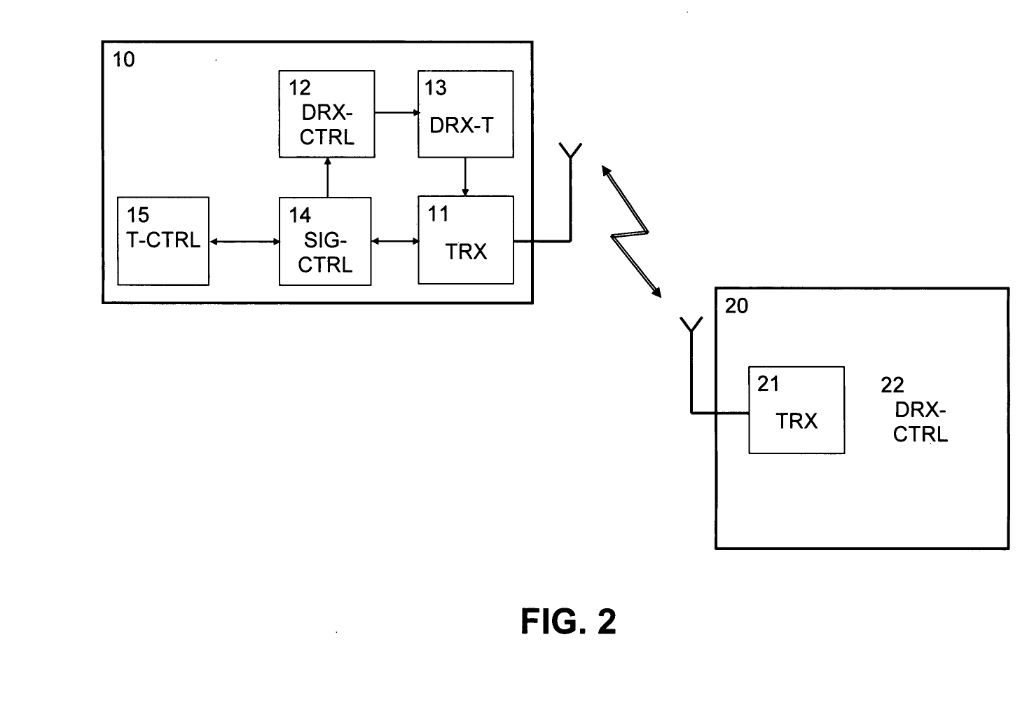

FIG. 2 shows an illustrative schematic block diagram which represents a mobile terminal or UE 10 and a base station device or node B 20 of a radio access network 30, to which in the following will be referred to more generally as the “network”. Both the UE 10 and the node B 20 may include transceiver (TRX) circuits 11, 21 for transmission and reception of wireless signals.

It is noted that the devices 10 and 20 of the block diagram of FIG. 2 only include certain illustrative components for demonstrating certain aspects of the DRX scheme as one approach to control heat generation in the UE via the set transmission data rate. Other possible components have been omitted from this example for reasons of simplicity.

Initially or as a default procedure, regular or normal DRX parameters may be determined and assigned to the UE 10 by the network and may be based on the current connection requirements. For that purpose, the node B 20 may include a DRX control function or DRX control unit 22 which may be configured to provide control signalling by using a suitable control layer for setting and controlling the DRX scheme applied at the UE 10. Typically (but not necessarily), as mentioned above, the DRX control unit 22 may use the Radio Resource Control (RRC) protocol layer for setting or changing the regular DRX scheme. Accordingly, the DRX control unit 22 may be part of or controlled by the RRC entity of the network.

In the UE 10 in this example, DRX is achieved by controlling the TRX circuit 11 by a respective DRX control unit 12 which may selectively control a DRX timer circuit 13 to count or measure a predetermined DRX cycle time or DRX interval. The timer setting may be controlled by a control signal received from the node B 20 and provided by the DRX control unit 22. For detecting the actual temperature, or more generally the actual heat generation in the UE 10 or at certain components of the UE 10, the UE may include a detector unit 15 for deriving the heat related information, which may be in the simplest implementation a temperature sensor. Additionally, the UE 10 may include a signalling control unit 14 configured to generate and process signalling messages exchanged with the network via the TRX circuit 11. Thus, the actual heat information can be indicated to the network, i.e. to the node B 20 in this example, by a signalling message generated by the signalling control unit 14.

In this example, the DRX cycle (also called “DRX period” or “DRX interval”) of the DRX timer circuit 13 of the UE 10 can be adjusted on the network side, upon the receipt of the heat related information provided by the UE 10 to the respective control unit in the node B 20 of the network 30.

It should be noted that the respective setting of the DRX timer circuit 13 is not restricted to time values (e.g., seconds, etc.) In other words, many other possible time period indications may be used, such as system specific timing units (e.g., duration of sub-frames, frames, etc.). Further, counter-based timings may be applicable, such as a certain amount/number of repetitions or instances of a certain message.

Additionally, the DRX timer circuit 13 and the DRX control unit 12 of the UE 10, as well as the DRX control unit 22 of the node B 20 may be implemented as programs or subroutines (e.g., as computer-readable media) controlling a processor device or computer device to implement the required functionalities. Alternatively, implementation of the above functionalities may be achieved by discrete hardware circuits or units.

According to other certain embodiments, a developing overheating condition at the UE 10 may indicate a change in UE's capabilities to the network, i.e. the node B 20. That is to say, if the UE 10 detects heat generation raising to a predetermined critical level it may signal a change in its capabilities. This could be, for example, a change in the UE's data throughput capabilities or the UE's minimum DRX capabilities, etc.

This example may require less or possibly even no changes at the node B 20, since the effect of providing heat related information from the UE 10 to the network may be provided implicitly or indirectly. In other words, the UE 10 may be configured such that the node B 20 or any other network element of the network 30, which is responsible or in charge of control for the actual transmission data rate, is informed of the capabilities of the UE 10 in such a manner that the network 30 or responsible network element may in turn adjust the effective data rate from the network to the UE 10. Hence, the dissipation losses in the UE 10 may be reduced by an increase of the DRX cycle time, in case the indication of a change in the UE's capabilities corresponds to the minimum DRX capabilities.

In another example, the UE 10 may be enabled to directly affect network based DRX control algorithm. As in previous examples, the UE 10 may include a component(s) to measure the actual heat generation or actual temperature of its critical electronic components, such as one or several temperature sensors, which may be used to detect overheating or indicate that a predetermined temperature measurement has been reached. Based on the heat related measurement data generated (e.g., by the detector 15), a control algorithm in the UE, which may be implemented in the signalling control unit 14, may generate a predetermined signal to the network. For instance, the UE 10 may send a request to the node B 20 to lower the DRX interval or to set DRX interval to specified value or range.

A network element responsible for DRX/DTX control may then assign and communicate the new DRX interval to the UE 10. As described in connection with previous examples, this network element may be the node B 20 which may include a DRX control function or unit 22 configured to provide control signalling by using a suitable control layer for setting and controlling the DRX scheme applied at the UE 10. The DRX control unit 22 may use the radio resource control (RRC) protocol layer for setting or changing the regular DRX scheme. Accordingly, the DRX control unit 22 may be part of or controlled by the RRC entity of the network. Alternatively, the request could also be a direct request to the network to lower the data throughput.

One potential advantage of such embodiments relates to the low implementation costs for present network devices. The control algorithm and associated control signalling may be implemented in software executed by the involved devices/elements. Additionally, any temperature sensor that may be used may typically be already available on hardware side of the user equipment.

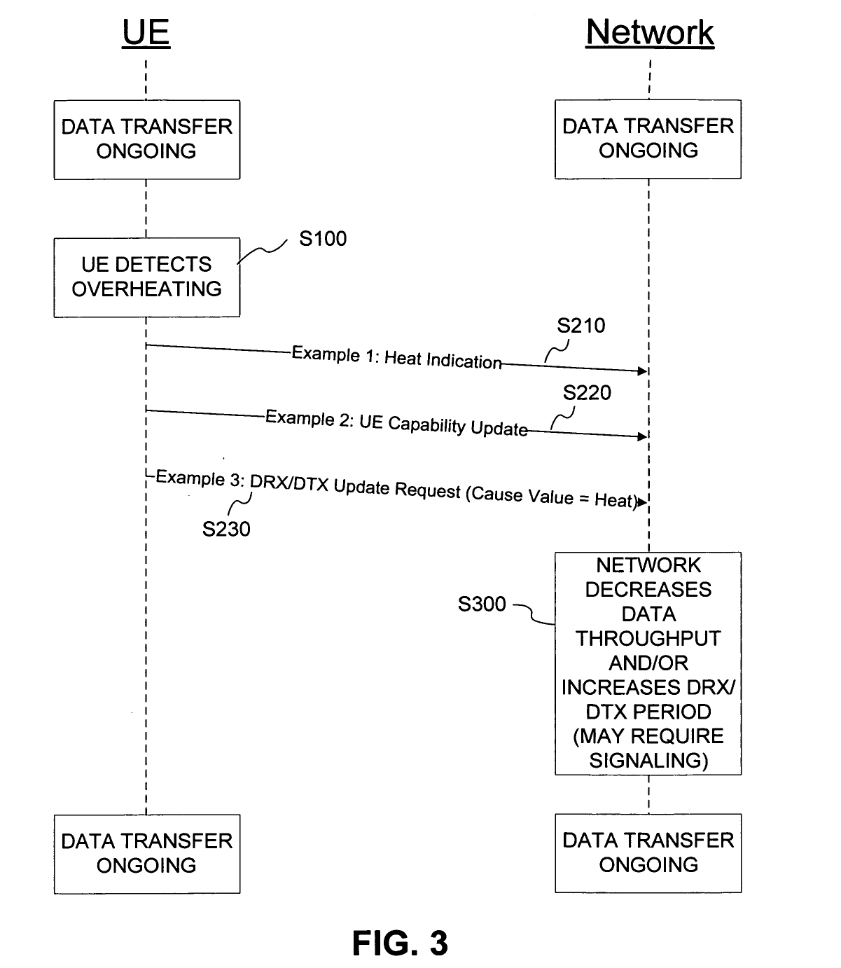

FIG. 3 shows a diagram illustrating certain different signalling implementations according to embodiments of the present invention. In these examples, there is an ongoing data transfer between the network NW and the user equipment UE. In block S100 the UE detects a potential overheating situation, which is caused by the electronic components of the UE involved in the data receiving operation generating more heat by dissipation losses than can be disposed to the environment of the UE by the actual temperature gap between the UE and the surrounding environment. A conventional approach of switching off the UE to avoid further heat generation may be undesirable since the user of the UE would not able to make use of the device.

In certain embodiments, the UE may be configured to alternatively or additionally inform the network by techniques shown in blocks S210, S220, and S230. By the approach of block S210, the UE may provide the network explicitly with heat related information, including a heat indication.

Further, by the approach of block S220, the UE may provide the network implicitly with heat related information, (e.g., as a capability update of the UE). In other words, by informing the network about a change of UE's capability, the network may adjust the inactivity period (DRX) and/or the actual data rate (data throughput) accordingly.

Furthermore, by the approach implemented by block S230 the UE may send the network a DRX/DTX update request, in which the UE may provide the network with a cause element alike “cause value==HEAT”. As before, the network may adapt or adjust the actual DRX interval for the UE accordingly, which may potentially require further signalling.

In block S300, the network may reduce the data throughput (data rate) to the UE or increase the DRX/DTX interval, which may potentially result in a reduced timely average of the data (transmission) rate.

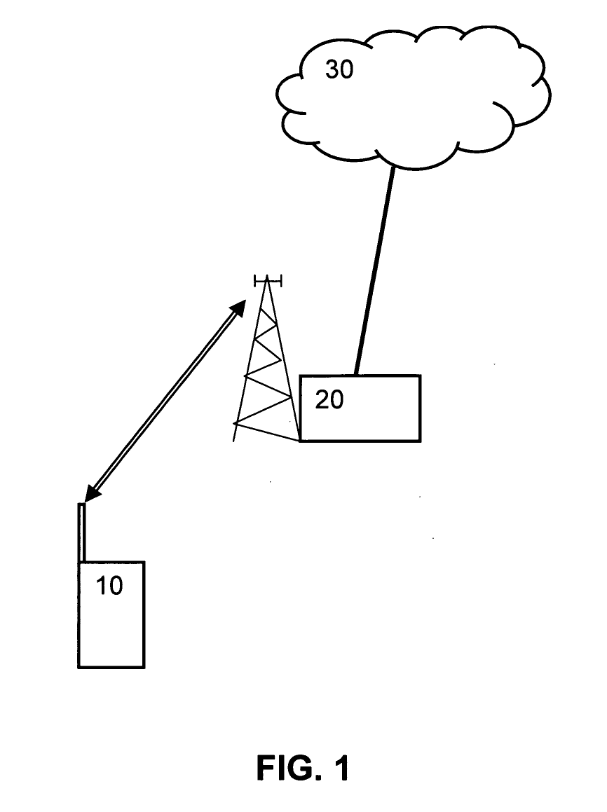

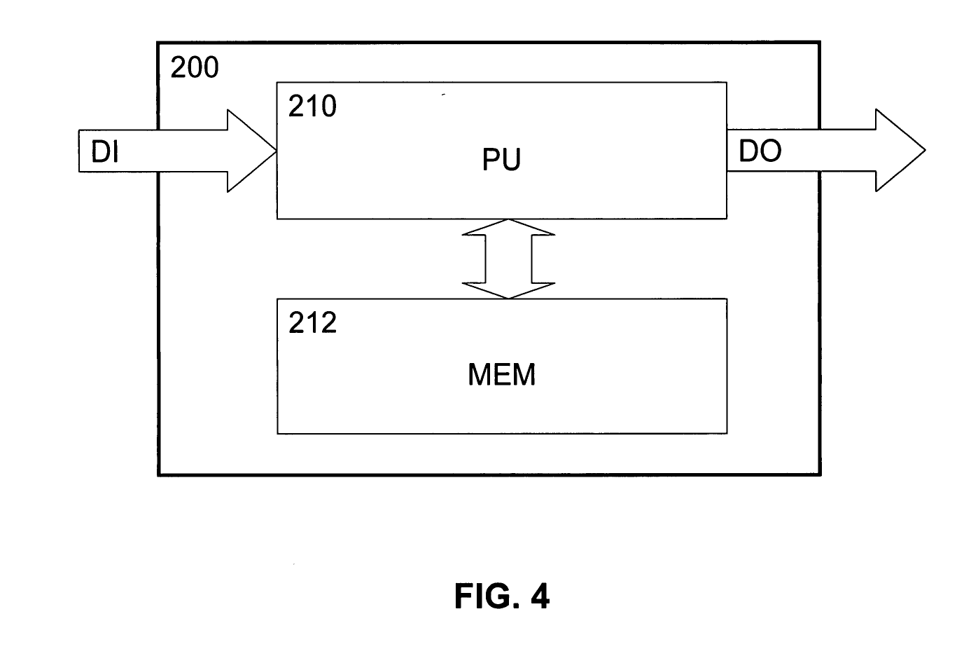

As noted above, the functionalities described in connection with FIGS. 1, 2, and 3 may be implemented as discrete hardware or signal processing units, and/or as computer readable media (e.g., software routines or programs) controlling a processor or computer device to perform the processing steps of the above functionalities. Accordingly, FIG. 4 shows an illustrative schematic block diagram reflecting a software-based implementation of the respective embodiments.

Accordingly, the device 200, which may be a component of the user equipment (e.g. a mobile terminal device) or the network element (e.g. a node B of the communication network), may include a processing unit 210, which may be any processor or computing device with a control unit which performs control based on software routines of a control program stored in a memory 212 provided in or at the device 200.

The software routines of a control program may include program code instructions which are fetched from the memory 212 and are loaded to the control unit of the processing unit 210 in order to perform the processing steps of the above functionalities described in connection with the FIGS. 1 to 3. The respective processing steps may be performed on the basis of input data DI and may generate output data DO, wherein the input and output data DI, DO may relate to the control signalling occurring at the device 200, which may be the user equipment or the network element.

Thus, certain embodiments described above provide methods, systems, network elements, terminal devices, and computer readable media (e.g., program products) for preventing the electronics in an electronic device such as a mobile terminal device from overheating in a communication network environment. Heat related information indicating heat generation or simple temperature at the terminal device may be communicated to the network element, causing the network element on the network side to adjust an inactivity period and/or an actual transmission data rate, (e.g., using DRX/DTX parameter adjustment), such that a further rise in temperature at the terminal device caused by dissipation losses in the involved electronic components of the terminal device might not occur. Additionally, a control loop may be constituted starting at the terminal device, which detects the heat related information, provides the heat related information explicitly or implicitly to the network, which may then adjust the inactivity period and/or the transmission data rate base on the provided heat related information. As a result, dissipation losses caused by an actual reception data rate from the network to the terminal device may potentially be controlled and reduced.

It is to be noted that the present invention is not restricted to the embodiments described above, but can be implemented in many different network environments in which terminal devices may suffer from high heat dissipation due to high data traffic provide from the network to the terminal device. Additionally, many different signalling techniques or types of messages may be used for transferring the heat information from the terminal device to the network. For example, the heat information may even be obtained based on a DRX related request.

While there have been shown and described and pointed out many different aspects as applied to the embodiments, it will be understood that various omissions and substitutions and changes in the form and details of the devices and methods described may be made by those skilled in the art without departing from the present invention. For example, it is expressly intended that all combinations of those elements and/or method steps, which perform substantially the same function in substantially the same way to achieve the same results, be within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method comprising:
generating at a data receiving terminal device heat related information based on at least one of heat generation and temperature of electronic components in the terminal device, said terminal device connected to a communication network sending data to the terminal device; and
sending the heat related information to the communication network, said heat related information causing the communication network to adjust at least one of an inactivity period and a throughput of data sent to the terminal device from the communication network in response to the heat related information.

2. A method comprising:
receiving heat related information at a communication network from a terminal device connected thereto, wherein the heat related information is based on at least one of a heat generation measurement and a temperature of electronic components in the terminal device; and
adjusting at least one of an inactivity period and a throughput of data sent from the network to the terminal device in response to the heat related information.

3. The method of claim 2, wherein the adjusting at least one of the inactivity period and the throughput of data comprises changing an interval of discontinuous reception (DRX) at the terminal device.

4. The method of claim 1, wherein the heat related information is sent from the terminal device to the communication network by one of L1 level messaging, L2 level messaging, or L3 level messaging.

5. The method of claim 1, wherein the heat related information comprises one bit indicating whether the current state of a heat generation measurement or a temperature at the terminal device requires adjustment.

6. The method of claim 1, wherein the heat related information comprises a plurality of bits corresponding to at least one of a relative or an absolute heat measurement of the terminal device.

7. The method of claim 1, wherein sending the heat related information to the communication network comprises signalling a change in terminal device capabilities, wherein the terminal device capabilities comprise at least one of a data throughput capability and a minimum DRX capability.

8. The method of claim 1, wherein the heat related information comprises one of a request to lower a DRX interval and a request to set a DRX interval to a specified value or range of values.

9. An electronic device comprising
at least one detector that detects heat related information corresponding to at least one of a heat generation measurement or a temperature of components of the electronic device; and
a signalling control unit configured to send the heat related information to a communication network connected to the electronic device,
wherein the heat related information comprises reference information for the communication network for adjusting at least one of an inactivity period and a throughput of data transmission from the communication network to the electronic device.

10. The electronic device of claim 9, further comprising a timer configured to time a discontinuous reception interval of a discontinuous reception scheme, wherein said interval is adjustable by the communication network to effect the inactivity period and the throughput of data sent to the electronic device from the communication network in response to the heat related information.

11. The electronic device of claim 10, wherein the adjusting at least one of the inactivity period and the throughput of data transmission comprises changing an interval of discontinuous reception at the electronic device.

12. The electronic device of claim 9, wherein the signalling control unit is configured to send the heat related information from the electronic device to the communication network by one of L1 level messaging, L2 level messaging, or L3 level messaging.

13. The electronic device of claim 9, wherein the heat related information comprises one bit indicating whether the current state of a heat generation measurement or a temperature at the electronic device requires adjustment.

14. The electronic device of claim 9, wherein the heat related information comprises several bits corresponding to at least one of a relative or an absolute heat measurement of the electronic device.

15. The electronic device of claim 9, wherein the signalling control unit is configured to send the heat related information to the communication network by signalling a change in device capabilities, wherein the device capabilities comprise at least one of a data throughput capability and a minimum DRX capability.

16. The electronic device of claim 9, wherein the signalling control unit is configured to send to the communication network one of a request to lower a DRX interval or a request to set a DRX interval to a specified value or range of values.

17. A network device comprising:
a control unit configured to control at least one of an inactivity period and a throughput of data transmission from a communication network to a terminal device connected to the network device, wherein the network device is configured to adjust the inactivity period or the throughput of data transmission based on reception of heat related information from the terminal device, wherein the heat related information is based on at least one of a heat generation measurement or a temperature of electronic components of the terminal device.

18. The network device of claim 17, wherein the control unit is configured to adjust the inactivity period or the throughput of data transmission by adjusting an allocated discontinuous receiving interval time for the receiving terminal device.

19. The network device of claim 17, wherein the control unit is configured to receive the heat related information from the terminal device by one of L1 level messaging, L2 level messaging, or L3 level messaging.

20. The network device of claim 17, wherein the heat related information comprises one bit indicating whether the current state of a heat generation measurement or a temperature at the terminal device requires adjustment.

21. The network device of claim 17, wherein the heat related information comprises several bits corresponding to at least one of a relative or an absolute heat measurement of the terminal device.

22. The network device of claim 17, wherein the terminal device comprises a signalling unit configured to send the heat related information to the communication network by signalling a change in terminal device capabilities, wherein the terminal device capabilities correspond to at least one of a data throughput capability and a minimum DRX capability.

23. The network device of claim 17, wherein the terminal device comprises a signalling unit configured to send to the communication network one of a request to lower a DRX interval or a request to set a DRX interval to a specified value or range of values.

24. One or more computer readable media storing computer-executable instructions which, when executed on a computer system, perform a method comprising:
generating at a data receiving terminal device heat related information based on at least one of a heat generation measurement and a temperature of electronic components in the terminal device, said terminal device connected to a communication network sending data to the terminal device; and
sending the heat related information to the communication network, said heat related information causing the communication network to adjust at least one of an inactivity period and a throughput of data sent to the terminal device from the communication network in response to the heat related information.

25. One or more computer readable media storing computer-executable instructions which, when executed on a computer system, perform a method comprising:
receiving heat related information at a communication network from a terminal device connected thereto, wherein the heat related information is based on at least one of a heat generation measurement and a temperature of electronic components in the terminal device; and
adjusting at least one of an inactivity period and a throughput of data sent from the network to the terminal device in response to the heat related information.
